(19) United States
(12) Patent Application Publication
(10) Pub. No.: US 2006/0065024 A1
(43) Pub. Date: Mar. 30, 2006

(54) Decorative lock cover

(76) Inventors: Glennda T. Gutierrez, Randolph, NJ (US); Sandra Cole, Piscataway, NJ (US)

Correspondence Address: Walter J. Tencza Jr.;Suite 3, 10 Station Place, Metuchen, NJ, 08840, US

(21) Appl. No.: 10/952,072

(22) Filed: Sep. 28, 2004

(51) Int. Cl. E05B 67/38

(52) U.S. Cl. 70/56

(57) ABSTRACT

A cover including first and second portions is disclosed for covering a lock. The lock includes an opening device. The lock may be a combination lock and the opening device may be a dial with numbers imprinted thereon. The lock can be at least partially placed inside of the first portion of the cover so that the opening device is surrounded by the first portion of the cover. The opening device can be operated by an individual to open the lock, while the cover is attached to the lock and while the first portion of the cover surrounds the opening device. The cover may include an ornamental design which can be seen when the cover is covering the lock.

### FIELD OF THE INVENTION

This invention relates to improved methods and apparatus concerning locks.

### BACKGROUND OF THE INVENTION

Padlock cases, in a general sense, are disclosed in the prior art. U.S. Pat. No. 3,983,725 to Manuel discloses a padlock case for keeping harmful elements, such as mud and water, away from the body portion of a padlock. U.S. Pat. No. 4,224,813 to Hampton discloses a padlock cover and shackle seal for weatherproofing. Generally, these patents disclose covering at least the body portions of the padlocks in a way which makes it impossible to open the padlocks without taking off the padlock cases or covers.

### SUMMARY OF THE INVENTION

It is an objective of the invention to provide a decorative lock cover which allows the user to incase their padlock or combination lock in their personalized lock cover with a name, photo, sports logo, or design displayed.

The present invention, in one or more embodiments, discloses an apparatus comprising a cover and a lock. The cover is typically comprised of first and second portions. The lock is comprised of an opening device. The lock may be a combination lock and the opening device may be a dial with numbers imprinted thereon.

Typically the lock can be at least partially placed inside of the first portion of the cover so that the opening device is surrounded by the first portion of the cover. The opening device can be operated by an individual to open the lock, while the cover is attached to the lock and while the first portion of the cover surrounds the opening device.

The cover may include an ornamental design which can be seen when the cover is covering the lock. The ornamental design may be located on an outer surface of the second portion of the cover. The first portion of the cover may include a first circular disk and a first peripheral wall which surrounds and is connected to the first circular disk. The second portion of the cover may include a second circular disk and a second peripheral wall which surrounds and is connected to the second circular disk. The shapes of the lock cover may vary.

The lock may have a body portion which can be placed inside of the cover and the cover can be closed to cover substantially the entire body portion of the lock. The second portion of the cover may be hinged to the first portion of the cover.

The cover may further include a clasp or other attachment device. The clasp can be used to attach the first portion of the cover to the second portion of the cover after the cover has been closed to substantially cover the body portion of the lock.

The present invention, in one or more embodiments, may also include placing a lock at least partially inside of a first portion of a cover so that an opening device of the lock is surrounded by the first portion of the cover, and operating the opening device of the lock, while the cover is attached to the lock and while the first portion of the cover surrounds the opening device.

### BRIEF DESCRIPTION OF THE DRAWINGS

FIG. 1A shows a perspective view of a cover in accordance with an embodiment of the present invention, with the cover shown in an opened state;

FIG. 1B shows a perspective view of a known combination lock in a locked state;

FIG. 1C shows a perspective view of the combination lock of FIG. 1B shown in an unlocked state wherein a loop portion has not been rotated;

FIG. 1D shows a perspective view of the combination lock of FIG. 1B shown in an unlocked state wherein the loop portion has been rotated;

FIG. 1E shows a perspective view of the combination lock of FIG. 1B placed in the cover of FIG. 1A, with the cover shown in an opened state;

FIG. 1F shows a perspective view of the apparatus of FIG. 1A in a closed state with the combination lock inside of the cover so that only the loop portion of the combination lock is showing;

FIG. 2 shows a front view of the cover of FIG. 1A in a closed state, without the combination lock;

FIG. 3 shows a rear view of the cover of FIG. 1A in a closed state, without the combination lock;

FIG. 4 shows a right side view of the cover of FIG. 1A in a closed state, without the combination lock,

FIG. 5 shows a left view of the cover of FIG. 1A in a closed state, without the combination lock;

FIG. 6 shows a perspective view of another embodiment of the present invention including a cover having a single opening through which a loop portion of a lock may be inserted;

FIG. 7 shows a perspective view of a loop portion of a lock inserted through the cover of FIG. 6;

FIG. 8 shows a perspective view of another embodiment of the present invention including a cover having a sound module, and first and second portions of a switch for activating the sound module; and

FIG. 9 shows a block diagram of the sound module, the first portion of the switch, and the second portion of the switch.

### DETAILED DESCRIPTION OF THE DRAWINGS

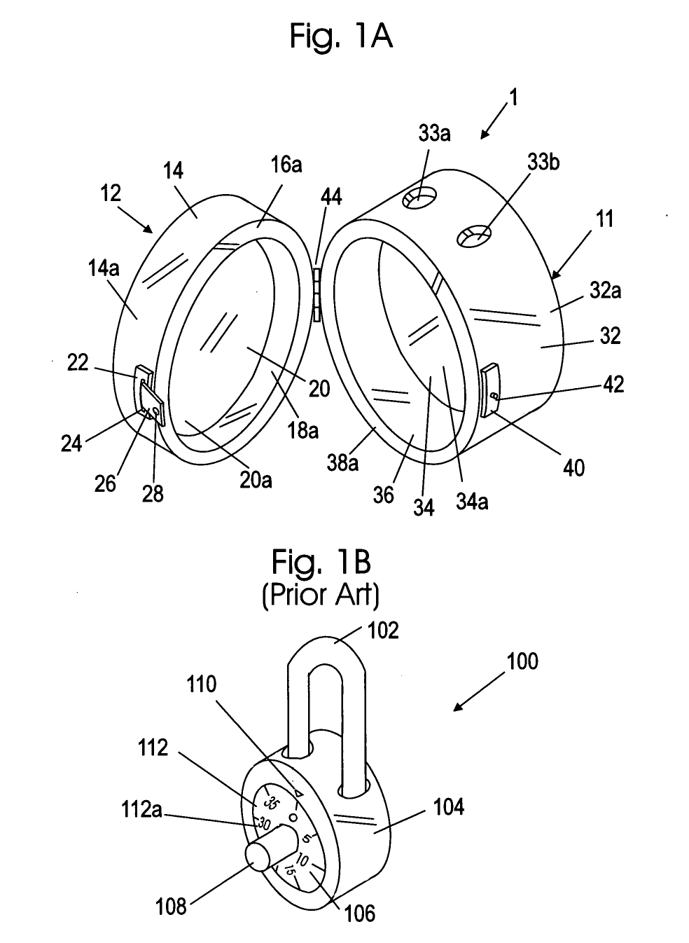

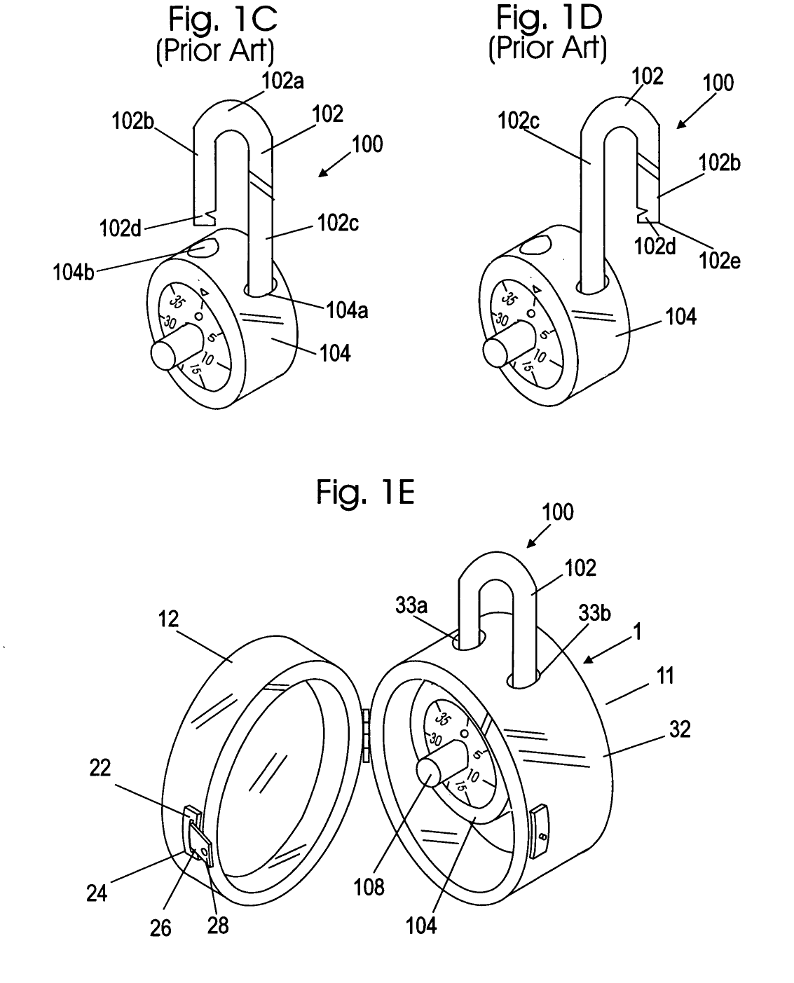

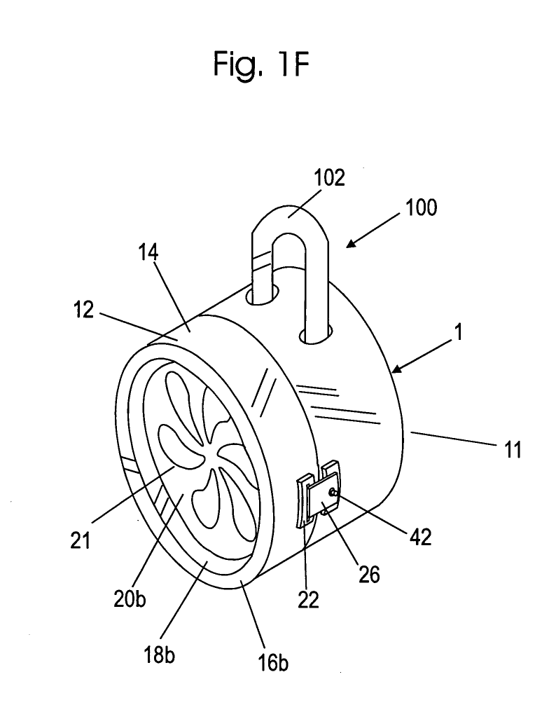

FIG. 1A shows a perspective view of a cover 1 in accordance with an embodiment of the present invention, with the cover 1 shown in an opened state. FIG. 1B shows a perspective view of a known combination lock 100 in a locked state. The combination lock 100 can be inserted into the cover 1.

FIG. 1C shows a perspective view of the combination lock 100 of FIG. 1B shown in an unlocked state wherein a loop portion 102 has not been rotated. FIG. 1D shows a perspective view of the combination lock 100 of FIG. 1B shown in an unlocked state wherein the loop portion 102 has been rotated. FIG. 1E shows a perspective view of the combination lock 100 placed in the cover 1, with the cover 1 shown in an opened state. FIG. 1 F shows a perspective view of the apparatus 1 of FIG. 1A in a closed state with the combination lock 100 inside of the cover 1 so that only the loop portion 102 of the combination lock 100 is showing.

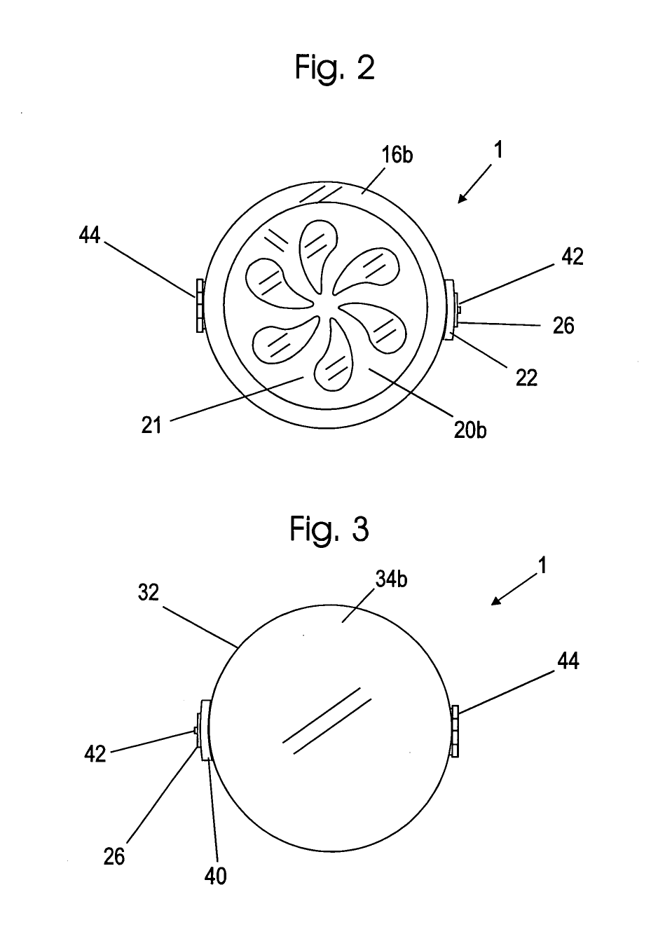

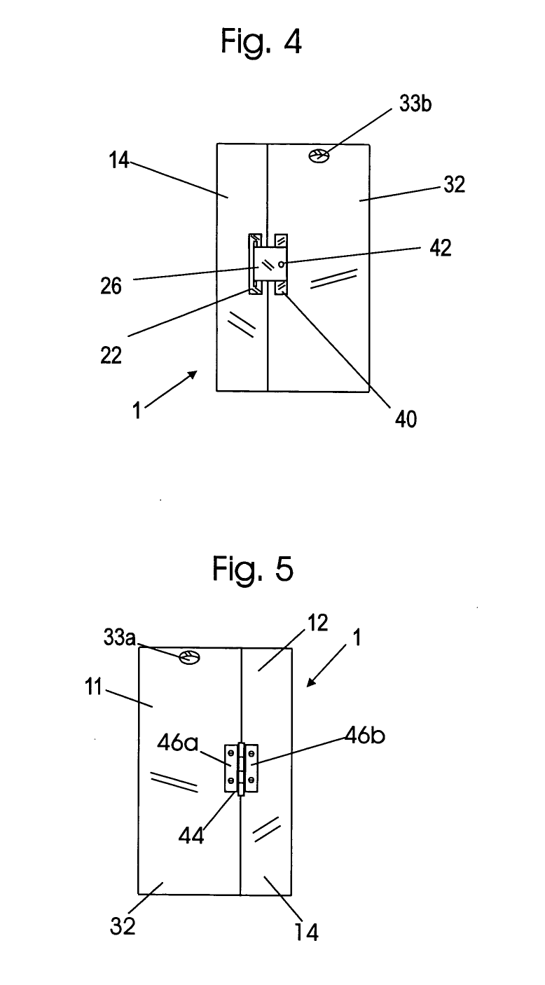

FIG. 2 shows a front view of the cover 1 of FIG. 1A in a closed state, without the combination lock 100. FIG. 3 shows a rear view of the cover 1 of FIG. 1A in a closed state, without the combination lock 100. FIG. 4 shows a right side view of the cover 1 of FIG. 1A in a closed state, without the combination lock 100. FIG. 5 shows a left view of the cover 1 of FIG. 1A in a closed state, without the combination lock 100.

The cover 1 includes a first portion 11 and a second portion 12. The first portion 11 may include a flat circular disk 34 surrounded by a peripheral wall 32. The peripheral wall 32 may have an inner edge 38a, shown in FIG. 1A. The peripheral wall 32 may include inner surface 36 shown in FIG. 1A. The peripheral wall 32 may include an outer surface 32a. The flat circular disk 34 may have an inner surface 34a shown in FIG. 1A and an outer surface 34b shown in FIG. 3. There are openings 33a and 33b through the wall 32.

The second portion 12 may include a flat circular disk 20 surrounded by a peripheral wall 14. The peripheral wall 14 may have an inner edge 16a, shown in FIG. 1A, and an outer edge 16b shown in FIG. 1F. The peripheral wall 14 may include inner surface 18a shown in FIG. 1A and inner surface 18b shown in FIG. 1F. The peripheral wall 14 may include an outer surface 14a. The flat circular disk 20 may have an inner surface 20a shown in FIG. 1A and an outer surface 20b shown in FIG. 1F. The outer surface 20b, as shown by FIG. 1F may have a design 21 printed thereon, such as flowers, stars, stripes, or any other kind of ornamental design.

The second portion 12 has attached thereto a member 22. A member 26, which may be a clasp or other attachment device, is attached by a hinge 24 to the member 22. The member 26 has an opening 28. The second portion 12 is attached to the first portion 11 by a hinge 44. As shown in FIG. 5, the hinge 44 may include portions 46a and 46b which are attached to portions 11 and 12, respectively.

The lock 100 may be a typically known combination lock. The lock 100 may include a loop or U-shaped portion 102 and a body portion 104 shown by FIGS. 1B-1D. The lock 100 includes a dial 106 having a knob 108 protruding there from. The dial 106 includes numbers 112 printed thereon such as number 112a or “30”. The lock may include a triangular indicator 110. The dial 106 can be spun in a known manner to align a number up with the indicator 110.

The lock 100 is shown in a locked state in FIG. 1B and in an unlocked state in FIGS. 1C and 1D. The loop portion 102 of the lock 100 includes portions 102b, 102a and 102c shown in FIG. 1C. The portions 102c and 102b can be called shackles. In an unlocked state the portion 102b has been completely removed from an opening 104b of the lock body portion 104. The portion 102b includes a notch 102d for attaching and locking inside of the opening 104b and inside of the lock body portion 104. The loop portion or U-shaped portion 102 can be rotated from the state of FIG. 1C to the state of FIG. 1D.

In operation, the lock 100, in its open state of FIG. 1D, can be placed inside the-cover 1. The cover 1 is first placed in an open state as in FIG. 1A. An end 102e of the loop portion 102 is placed inside the portion 11 and then inserted up through the opening 33b through the inside surface 36 and through wall 32. The end 102e may then be inserted into an opening of a locker or cabinet. The end 102e is then inserted into the opening 33a of the outer surface 32a and back into the portion 11 of the cover 1. The body portion 104 of the lock 100 is then inside of the portion 11 as shown in FIG. 1E. The lock 100 can be left in an unlocked state, with the notch 102d taken out of the opening 104b of the body portion 104 as in FIG. 1C or in a locked state with the notch 102d placed inside of the opening 104b and locked.

With the body portion 104 of the lock 100 placed inside of the cover 1, as in FIG. 1E, the cover 1 can be closed as shown in FIG. 1F. The member or clasp 26 can be rotated into a closed position, so that the protrusion 42 is inserted through the opening 28. Various attachment devices or latching devices can be provided instead of or in addition to the components 22, 24, 26, 28, 40, and 42.

The design 21 can be replaced by a person's name, a photo, a logo, a design or picture related to sports or some other activity, or any other design. Some designs will play musical themes. Lock cover may contain a music module that plays a melody when lock cover is opened.

The walls 14 and 32, and the disks 20 and 34 can be constructed out of various materials such as wood, paper mache, metal, tin, plastic, or cardboard. A pad lock can be used instead of a combination lock The cover 1 can cover, for example, padlocks and combination locks that are placed on lockers and cabinets.

The portions or shackles 102b, 102a, or 102c can be placed thru the hole of a locker, cabinet, or chain and the lock 100 can be locked. Once the lock 100 is locked the portion 12 can be closed over the lock 100 inside of the portion 11 as shown by FIGS. 1E and 1F. The result is that a design, such as design 21 will be displayed.

The present invention seeks to provide a means by which lock covers can be personalized, i.e., where people can have their own lock covers with their names, photos, sports, logos, and designs. A decorative lock cover personalizes a person's style. The box or cover 1 can come in various shapes and sizes.

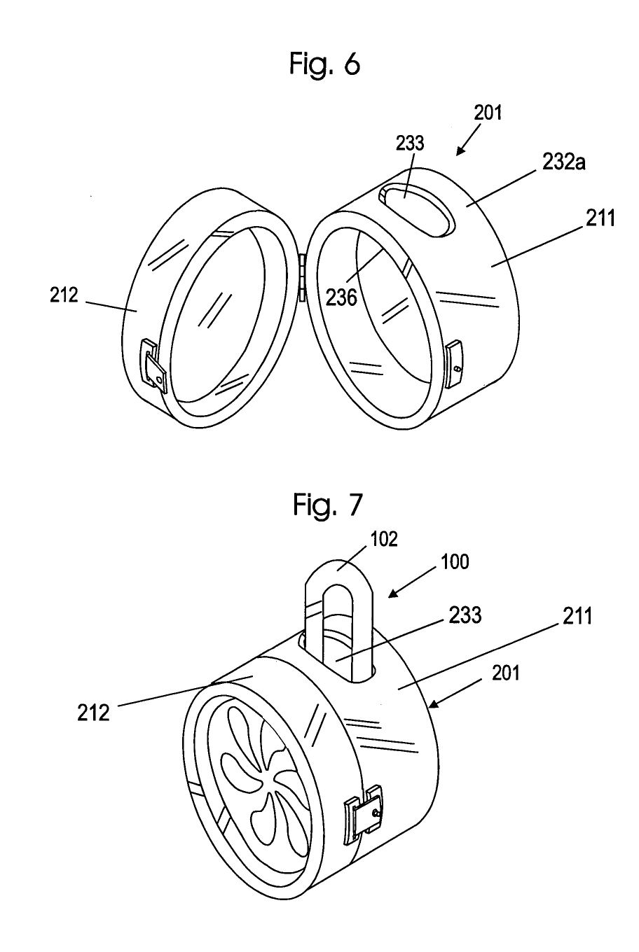

FIG. 6 shows a perspective view of another embodiment of the present invention including a cover 201 having a single opening 233 through which loop portion 102 of a lock 100 may be inserted. FIG. 7 shows a perspective view of loop portion 102 of lock 100 inserted through the opening 233 of the cover 201 of FIG. 6. The cover 201 may be identical to the cover 1 except that the single opening 233 of cover 201 replaces the two openings 33a and 33b and the portion of outer surface 32a between the openings 33a and 33b. In operation the loop portion 102 can be inserted into the opening 233 up through inner surface 236 and out through outer surface 232a. The end 102e of the loop portion 102 can then be inserted through a locker, cabinet, or chain which may be included with lock cover opening and then be locked to the body portion 104 shown in FIGS. 1B-1E. The body portion 104 will be inside the cover 201 and the loop portion 102 will protrude out of the opening 233 as shown in FIG. 7. A portion 212 of the cover 201 may then be closed and attached to a portion 211 of the cover 201, as shown in FIG. 7. The portion 212 may be identical to the portion 12 of the cover 1. The portion 211 may be identical to the portion 11 of the cover 1, with the exception of the difference between the opening 233 and the openings 33a-b and the surface between the openings 33a-b.

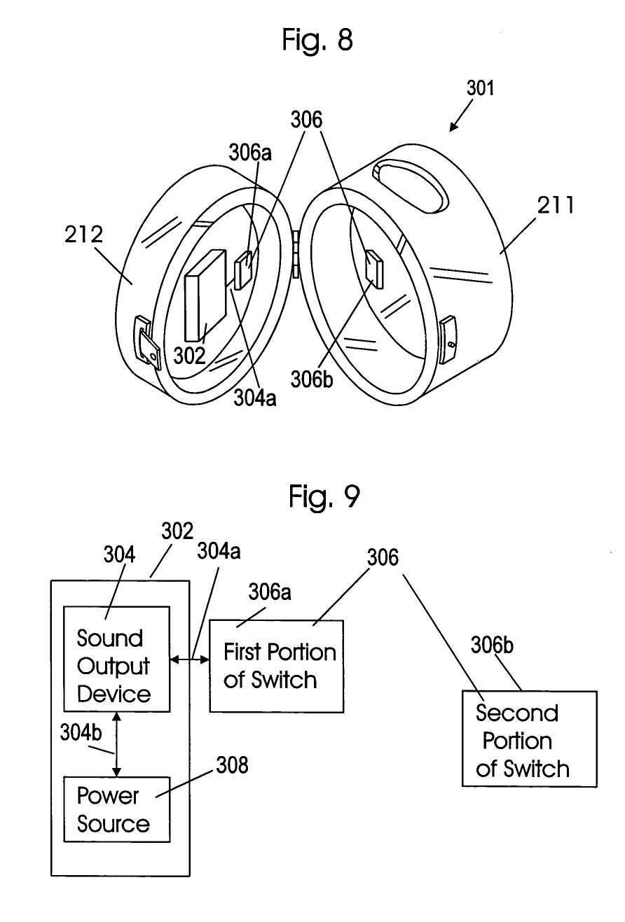

FIG. 8 shows a perspective view of another embodiment of the present invention including a cover 301 having a sound module 302, and first and second portions 306a and 306b of a switch 306 for activating the sound module 302. The cover 301 may include portions 211 and 212 the same as the cover 201 of FIG. 6. The portion 212 may have attached thereto the sound module 302 and the first portion 306a of the switch 306. The second portion 306b of the switch 306 may be attached to the portion 211 of the cover 301.

FIG. 9 shows a block diagram of the sound module 302, the first portion 306a of the switch 306, and the second portion 306b of the switch 306. The sound module may include a sound output device 304 connected by a link 304b to a power source 308 shown in FIG. 9. The first portion 306a may be connected by a link 304a to the sound output device 304. The sound output device 304 by itself or together with the power source 308 or switch 306 may be an electronic musical melody module and may be of a type commonly used in greeting cards, such as birthday cards wherein a “Happy Birthday” melody is played when the greeting card is opened. The sound output device 304 may be comprised of a speaker and an integrated circuit tone modulator. Power source 308 may be a battery. The first portion 306a of the switch 306 may be a photodiode, light detector, or light sensitive switch. The second portion 306b of the switch 306 may be a light emitting diode (LED). When the cover 301 is closed, similar to as shown for cover 201 in FIG. 7, the first portion 306a may receive light from the second portion 306b and thereby cause the sound output device 304 to be out of circuit or disconnected from the power source 308 or in some other manner may prevent the sound output device 304 from emitting sound. When the cover 301 is open, as in FIG. 8, the first portion 306a of the switch 306 may not receive light from the second portion 306b, which may cause the sound output device 304 to be connected to the power source 308, or may in some other manner cause sound to be emitted from the sound output device 304. The sound output device 304 may include any type of sound output device, such as a radio or CD (compact disc) player.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

1. An apparatus comprising:
a cover including a first portion; and
a lock comprised of an opening device;
wherein the lock can be at least partially placed inside of the first portion of the cover so that the opening device is surrounded by the first portion of the cover;
wherein the opening device can be operated by an individual to open the lock, while the cover is attached to the lock and while the first portion of the cover surrounds the opening device;
wherein the cover has an outer surface and there is a photo located on the outer surface;
and wherein the photo can be seen when the cover is covering the lock.

2. The apparatus of claim 1 wherein
the lock is a combination lock and the opening device is a dial.

3. The apparatus of claim 1 wherein the cover includes a music module that plays a melody when the cover is opened.

4. The apparatus of claim 1 wherein
the first portion of the cover includes a first circular disk and a first peripheral wall which surrounds and is connected to the first circular disk.

5. The apparatus of claim 4 wherein
the cover includes a second portion;
wherein the second portion includes a second circular disk and a second peripheral wall which surrounds and is connected to the second circular disk.

6. The apparatus of claim 5 wherein the second circular disk has an outer surface having a photo;
and wherein the lock has a body portion which can be placed inside of the cover and the cover can be closed to cover substantially the entire body portion of the lock.

7. The apparatus of claim 5 wherein
the second portion of the cover is hinged to the first portion of the cover.

8. The apparatus of claim 7 wherein
the lock further includes a body portion;
and the cover further includes a clasp;
wherein the clasp can be used to attach the first portion of the cover to the second portion of the cover after the cover has been closed to substantially cover the body portion of the lock.

9. A method comprising
placing a lock at least partially inside of a first portion of a cover so that an opening device of the lock is surrounded by the first portion of the cover;
operating the opening device of the lock, while the cover is attached to the lock and while the first portion of the cover surrounds the opening device; and
providing the cover with a music module that plays a melody when the cover is opened.

10. The method of claim 9 wherein
the lock is a combination lock and the step of operating the opening device includes spinning a dial of the combination lock.

11. The method of claim 9 wherein
the first portion of the cover includes a first circular disk and a first peripheral wall which surrounds and is connected to the first circular disk.

12. The method of claim 11 wherein
the cover includes a second portion;
wherein the second portion includes a second circular disk and a second peripheral wall which surrounds and is connected to the second circular disk.

13. The method of claim 9 wherein
wherein the cover has an outer surface and there is a photo on the outer surface.

14. The method of claim 12 wherein
the second portion of the cover is hinged to the first portion of the cover.

15. The method of claim 14 wherein
the lock further includes a body portion;
and the cover further includes a clasp;
wherein the clasp can be used to attach the first portion of the cover to the second portion of the cover after the cover has been closed to substantially cover the body portion of the lock.

16. An apparatus comprising
a cover for covering a lock,
wherein the cover can be closed to cover an opening device of the lock; and
wherein the cover can be opened to expose the opening device of the lock; and
further comprising a sound output device attached to the cover;
wherein the sound output device emits sound when the cover is opened to expose the opening device of the lock.

17. The apparatus of claim 16 further comprising
a switch;
and wherein the switch causes the sound output device to emit sound when the cover is opened to expose the opening device of the lock.

18. The apparatus of claim 17 wherein
the cover includes a first portion and a second portion;
the switch includes a first portion and a second portion; and
wherein the first portion of the switch is attached to the first portion of the cover and the second portion of the switch is attached to the second portion of the cover.

19. The apparatus of claim 16 wherein
the cover has a design imprinted thereon.

20. The apparatus of claim 16 wherein
the cover has an outer surface and there is a photo located on the outer surface.
